(19) United States
(12) Patent Application Publication
(10) Pub. No.: US 2015/0254682 A1
(43) Pub. Date: Sep. 10, 2015

(54) HARMONIZED SYSTEM NUMBER ANALYSIS

(71) Applicant: Export Abroad, Inc., Madison, WI (US)

(72) Inventors: Austin Grandt, Madison, WI (US); William Hakizimana, Madison, WI (US)

(21) Appl. No.: 14/642,148

(22) Filed: Mar. 9, 2015

Related U.S. Application Data
(60) Provisional application No. 61/949,607, filed on Mar. 7, 2014.

(51) Int. Cl. G06Q 30/02

(52) U.S. Cl. CPC G06Q 30/0201

(57) ABSTRACT

One example of a system includes a crawler, a normalizer, an interface, and an analysis engine. The crawler accesses data sources to retrieve an indicator value for each of a plurality of indicators for each of a plurality of countries. The indicators include economic indicators, import/export indicators for each of a plurality of Harmonized System (HS) numbers, and world trade indicators. The normalizer scrubs and normalizes each retrieved indicator value. The interface receives a request for a report for a selected HS number from the plurality of HS numbers and provides the requested report for the selected HS number after the report is generated by the analysis engine. The analysis engine processes the indicator values for the selected HS number to provide the requested report for the selected HS number indicating a success for sales of the product indicated by the selected HS number in each country.

### CROSS-REFERENCE TO RELATED APPLICATIONS

This Non-Provisional U.S. patent application claims the benefit of U.S. Provisional Application Ser. No. 61/949,607, filed Mar. 7, 2014, entitled “Market Research Analysis,” and which is incorporated herein by reference.

### BACKGROUND

In recent years, international trade has seen an immense amount of growth as countries continue to increase their volume of importing and exporting of goods. The increase in volume can be attributed to a mixture of globalization, technology advancement, and transnational trade agreements. As companies look to expand product offerings to different countries, market research is conducted in an attempt to make informed business decisions. Currently, market research is typically conducted as primary research (i.e., by collecting or analyzing original primary data), where companies conduct surveys to ask consumers about preferences regarding products offered by the company. This type of research, while often informative, is expensive and time consuming. Due to inherent costs, this type of research is further limited by breadth and/or geographic scope.

### BRIEF DESCRIPTION OF THE DRAWINGS

FIG. 1 is a block diagram illustrating one example of a system for analyzing Harmonized System (HS) numbers.

FIG. 2 is a block diagram illustrating one example of an HS number analysis system.

FIG. 3 is an example user interface display for receiving a request for an HS number report.

FIG. 4 is an example user interface display for a report for a selected HS number.

FIG. 5 is a block diagram illustrating one example of a processing system for implementing an HS analysis system.

FIG. 6 is a flow diagram illustrating one example of a method for analyzing an HS number.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Concepts presented herein assist users in making trade decisions based on data that is presented in a format that is easily understood. The data provides users with an idea of whether a particular product would be successful in a target market. By obtaining, aggregating, and analyzing data from separate sources, market research can easily be presented in real time (i.e., within a few seconds) in response to a user request.

Examples of the disclosure describe the generation of market research reports by analyzing data (i.e., market indicators) to identify potential target markets. A plurality of indicators from one or more sources are selectively managed and updated for a plurality of product identification codes for a plurality of countries. For a selected product identification code, a score is calculated based on the plurality of indicators. The score provides an indication of success of product sales associated with the product identification code for a particular market.

In one example, the product identification code is a Harmonized System (HS) number of the Harmonized System of tariff nomenclature. The Harmonized System of tariff nomenclature is an internationally standardized system of names and numbers to classify traded products. The Harmonized System is developed and maintained by the World Customs Organization (WCO), which is an independent intergovernmental organization based in Brussels, Belgium. For example, an HS number of 6211 is for swimwear. The HS number may be extended to six digits. For example, HS number 621111 is for men's or boys' swimwear.

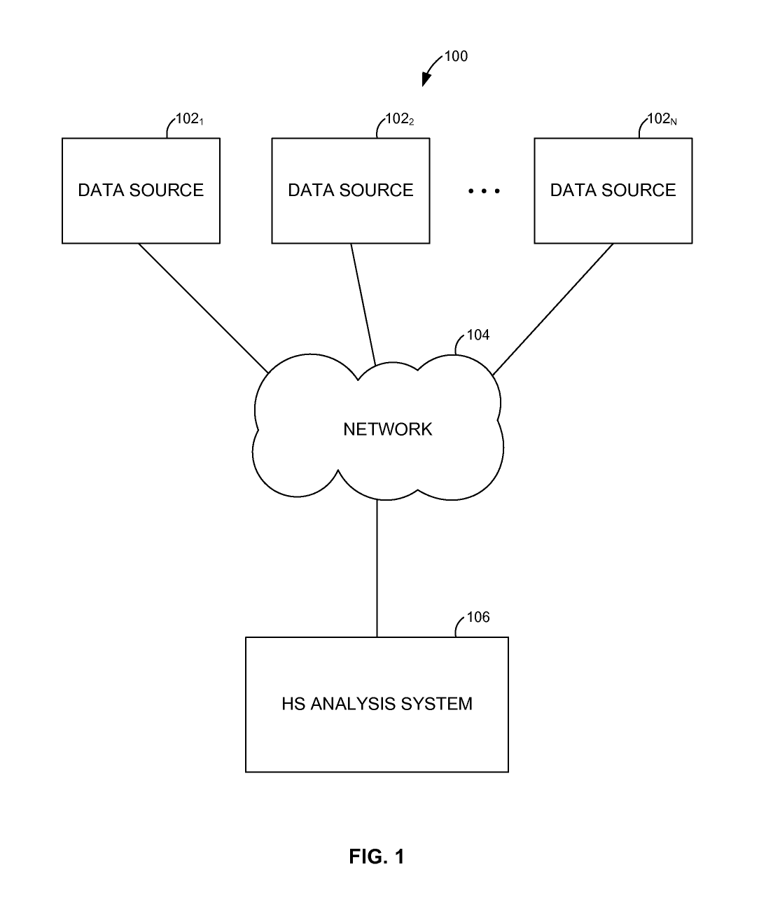

FIG. 1 is a block diagram illustrating one example of a system 100 for analyzing Harmonized System (HS) numbers. System 100 includes a plurality of data sources 102₁-102_{N}, where “N” is any suitable number of data sources, a network 104, and an HS analysis system 106. HS analysis system 106 is communicatively coupled to each data source 102₁-102_{N} through network 104. In one example, network 104 may include the Internet, a wide area network, a local area network, another suitable network, or combination thereof.

HS analysis system 106 accesses data sources 102₁-102_{N} to retrieve data used for analyzing HS numbers. Data sources 102₁-102_{N} can include both publically available data and/or private data. Example data sources include, but are not limited to, the World Bank, Global Trade Atlas, World Trade Organization, PIERS, Google, Twitter, Facebook, Instagram, and Alibaba. The data sources 102₁-102_{N} are each queried periodically by HS analysis system 106. The retrieved data includes market indicators for each country (e.g., every country in the world or a selected subset of countries). The market indicators may include economic indicators, import/export indicators for each HS number, world trade indicators, and other indicators as will be further described below. HS analysis system 106 maintains updated indicator values for each indicator for each country and each HS number.

The retrieved data for a selected HS number is then processed by HS analysis system 106 to provide a report indicating whether a product indicated by the selected HS number is likely to be successful in any of a plurality of countries. The selected HS number may be input by a user and the report indicating the likely market success of a product indicated by the HS number in each country may be provided to the user. In one example, HS analysis system 106 ranks the countries based on the likely market success of the product indicated by the HS number and provides a report listing a subset of countries having the highest rank.

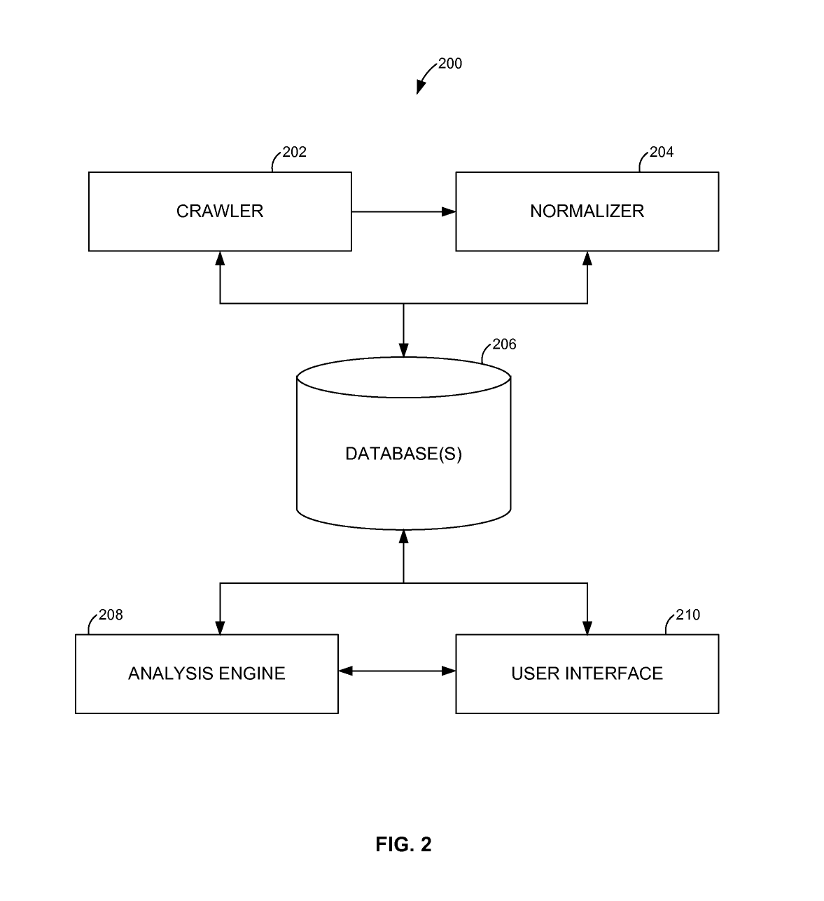

FIG. 2 is a block diagram illustrating one example of an HS number analysis system 200. In one example, HS analysis system 200 provides HS analysis system 106 previously described and illustrated with reference to FIG. 1. HS analysis system 200 includes a crawler 202, a normalizer 204, a database or databases 206, an analysis engine 208, and a user interface 210. Crawler 202 is communicatively coupled to normalizer 204, and normalizer 204 and crawler 202 are communicatively coupled to database(s) 206. Analysis engine 208 is communicatively coupled to user interface 210, and user interface 210 and analysis engine 208 are communicatively coupled to database(s) 206.

Database(s) 206 may include one database or multiple databases for storing the data collected and processed by HS analysis system 200. In one example, database(s) 206 include at least one collection database, at least one staging database (e.g., two staging databases), and at least one production database which are each used by at least one of crawler 202, normalizer 204, analysis engine 208, and user interface 210. In other examples, other suitable database structures may be used for the collection, management, and processing of data used by HS analysis system 200. In one example, by dividing the data used by HS analysis system 200 into separate databases, efficiencies are gained in the processing of the data.

Crawler 202 may include Application Programming Interface (API) modules to access (i.e., crawl) data sources for new data and/or other suitable modules to access data sources for new data. Crawler 202 periodically queries the data sources to check for new or updated data. If new or updated data is found in a query, the new or updated data is sent to normalizer 204 and/or to database(s) 206. Each data source may be queried by crawler 202 based on an update frequency of the data source.

In one example, each data source provides at least one of three types of data including low frequency data, high frequency data, and HS number data. Low frequency data includes information that is updated relatively infrequently, such as on a six month to yearly basis. Low frequency data includes, for example, Gross Domestic Product (GDP) and income per capita. High frequency data includes information that is constantly changing or updated relatively frequently. High frequency data includes, for example, data on social media and shopping trends. High frequency data may be queried multiple times a day by crawler 202. HS number data includes information directly tied to an HS number. HS number data includes, for example, tariffs and import and export data. Crawler 202 queries each data source at different frequencies based on the type of data provided by each data source. By separating the data into the three types, the data is more easily managed and processed within HS analysis system 200. In other examples, the data may be separated into other or additional types for management and processing within HS analysis system 200.

Normalizer 204 scrubs and normalizes the data retrieved by crawler 202. In one example, normalizer 204 receives data to be scrubbed and normalized directly from crawler 202. In another example, normalizer 204 retrieves data stored in database(s) 206 to be scrubbed and normalized. Normalizer 204 scrubs the retrieved data to remove any irrelevant information and formats the data so that data from different data sources is in the same form for storage in database(s) 206 and for further processing by analysis engine 208.

Analysis engine 208 retrieves scrubbed and normalized data from database(s) 206 to process the data and generate reports for selected HS numbers. An HS number for which a report is desired may be entered by a user via user interface 210. In one example, analysis engine 208 combines low frequency data, high frequency data, and HS number data for each of a plurality of countries and determines whether sales of the product indicated by a selected HS number is likely to be successful in each country. Analysis engine 208 generates reports based on the results of the data processing. The reports may include a ranking of countries for a selected HS number. The reports may be provided to a user via user interface 210.

Analysis engine 208 queries database(s) 206 when a user submits up to the first six digits of an HS number via user interface 210. Based on a number of indicators retrieved from database(s) 206, analysis engine 208 generates a report providing an analysis of foreign markets for the product indicated by the selected HS number. Example indicators may include general economic data, general import/export statistics for a given HS number (based on up to the first six digits of each HS number), world trade indicators, and other indicators such as social media trends and/or demand trends.

Example general economic indicators may include: GDP, GDP growth, discretionary income, income per capita, money growth (e.g., growth of average amount in savings accounts), inflation, and/or population demographics. Examples of general import/export indicators for a given HS number may include: taxes and tariffs, amount imported, amount exported, trade imbalance, estimated shipping cost, average paperwork cost, and/or imports of goods and services percentage. Example world trade indicators may include: strength of legal right index, number of documents to import, logistics performance index, labor participation rate, and/or ease of doing business index. Examples of other indicators may include: instantaneous demand data (e.g., keeping track of product demand in countries across the globe), Twitter data, Google shopping data, Instagram data, Alibaba data, estimated shipping costs, cost of goods pricing, indicators that allow to spot for pricing arbitrage opportunities, average purchase price of goods, a measure of trade of goods across the globe, a measure of what customers are searching for and/or shipping, a measure of PIERS (e.g., international shipping) data, and/or a measure of global news trends. In other examples, other suitable indicators that provide an indication of market demand may be used in place of or in addition to the indicators described above.

Analysis engine 208 assigns a weight to each indicator based on a potential level of success for goods in a market. Each scrubbed and normalized indicator value for each country for the selected HS number is multiplied by the assigned weight for the indicator to provide a weighted value for each indicator for each country for the selected HS number. Analysis engine 208 then sums the weighted values for each country to provide a total value for each country. The total values may be ranked to generate a report for the selected HS number. The report may be provided to the user to indicate a success for sales of the product indicated by the selected HS number in each country.

The processing performed by analysis system 208 described above may be summarized as follows:

For a given number of indicators X, wherein each indicator value is scrubbed and normalized and multiplied by an assigned weight, a total value for each country is calculated by:

Σ(Indicator 1:Indicator X)=Total Value

Using the total value for each country, a rank may be established from largest total value (best country) to lowest total value (worst country). This ranking may be supplied to the user via user interface 210 to indicate a success for sales of the product indicated by the selected HS number in each country.

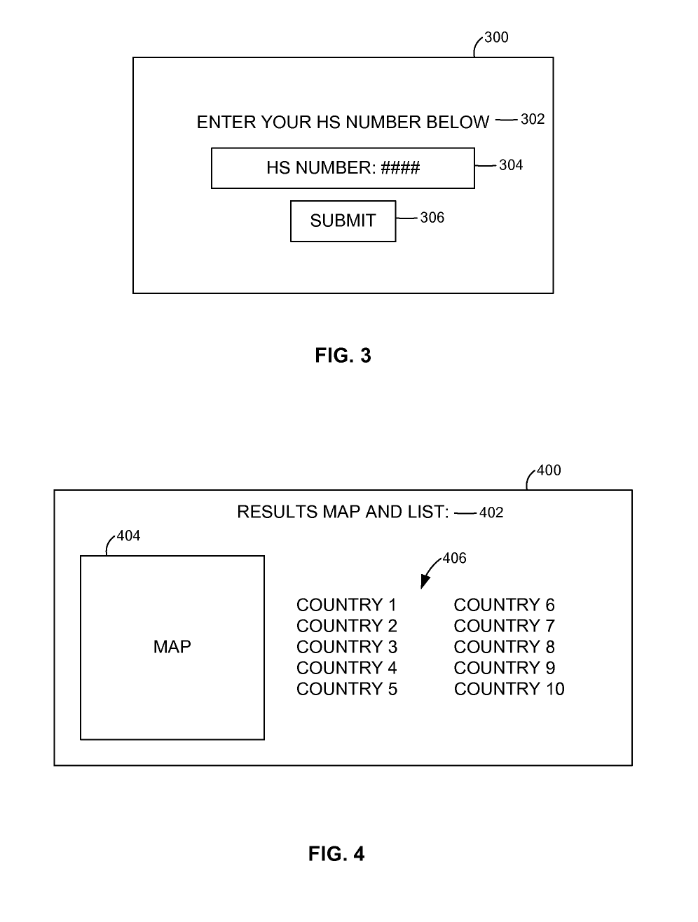

FIG. 3 is an example user interface display 300 for receiving a request for an HS number report. User interface display 300 may be a web page or a portion of a web page. User interface display 300 includes a prompt 302, an input box 304, and a submit button 306. Prompt 302 prompts a user to enter an HS number. While in this example, the prompt reads “ENTER YOUR HS NUMBER BELOW,” in other examples other suitable prompts may be used. Input box 304 receives an HS number from a user via an input device, such as a keyboard, mouse, touchscreen, etc. In one example, the input is checked while being entered to validate that the input is a valid HS number. Once a valid HS number has been entered in input box 304, pressing of the submit button 306 initiates the generation of the report for the entered HS number. After generation of the report, the report is provided to the user, such as via user interface display 400 described below with reference to FIG. 4.

FIG. 4 is an example user interface display 400 for displaying a report for a selected HS number. User interface display 400 may be a web page or a portion of a web page. The report includes a title 402, a map 404, and a ranked list of countries 406. While in this example, the title reads “RESULTS MAP AND LIST:,” in other examples other suitable titles may be used. Map 404 may include a world map with the locations of countries listed in the country list 406 highlighted in the map. While country list 406 includes the top ten countries where the product indicated by the selected HS number is most likely to be successful, any suitable number of countries may be listed. Country list 406 may also list the total value calculated for each country from the indicator values for the selected HS number. In another example, country list 406 may list a subset of the indicator values used in the calculation for each country. In yet another example, selecting one of the countries in country list 406 may open a new window or page providing detailed information about the selected country for the selected HS number.

While one example of a user interface display for a report is illustrated in FIG. 4, the particular information included in the report and the particular format of the report may vary. In addition to or in place of the report being displayed to the user, the report may be provided in printed form or in a computer file, such as a Portable Document Format (PDF) file.

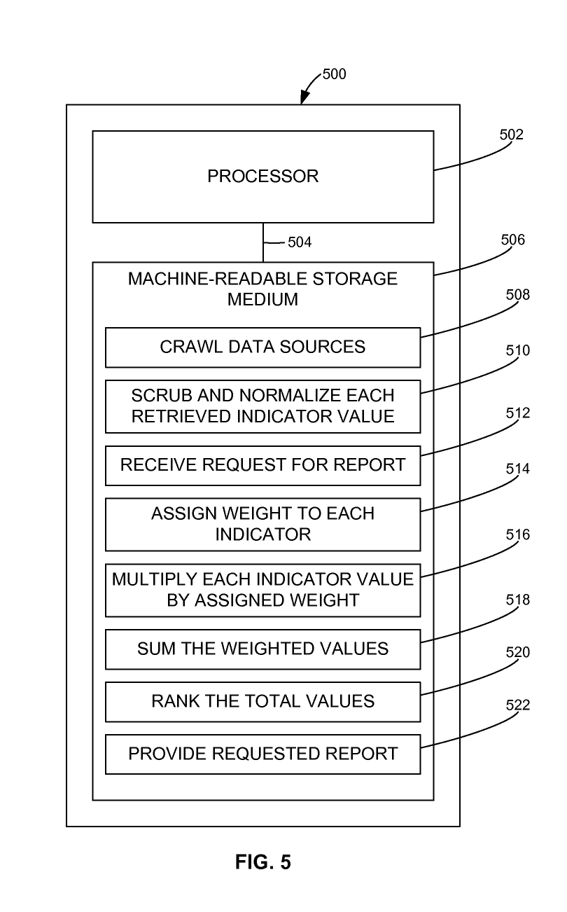

FIG. 5 is block diagram illustrating one example of a processing system 500. Processing system 500 may include at least one computing device and may provide HS analysis system 200 previously described and illustrated with reference to FIG. 2. System 500 includes a processor 502 and a machine-readable storage medium 506. Processor 502 is communicatively coupled to machine-readable storage medium 506 through a communication path 504. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 includes one or more Central Processing Units (CPUs), microprocessors, and/or other suitable hardware devices for retrieval and execution of instructions stored in machine-readable storage medium 506. Processor 502 may fetch, decode, and execute instructions 508 to crawl data sources, instructions 510 to scrub and normalize each retrieved indicator value, instructions 512 to receive a request for a report, instructions 514 to assign a weight to each indicator, instructions 516 to multiply each indicator value by the assigned weight, instructions 518 to sum the weighted values, instructions 520 to rank the total values, and instructions 522 to provide the requested report.

As an alternative or in addition to retrieving and executing instructions, processor 502 may include one or more electronic circuits comprising a number of electronic components for performing the functionality of one or more of the instructions in machine-readable storage medium 506, such as a Field Programmable Gate Array (FPGA). With respect to the executable instruction representations (e.g., boxes) described and illustrated herein, it should be understood that part or all of the executable instructions and/or electronic circuits included within one box may, in alternate examples, be included in a different box illustrated in the figure or in a different box not shown.

Machine-readable storage medium 506 is a non-transitory storage medium and may be any suitable electronic, magnetic, optical, or other physical storage device that stores executable instructions. Thus, machine-readable storage medium 506 may be, for example, Random Access Memory (RAM), an Electrically-Erasable Programmable Read-Only Memory (EEPROM), a storage drive, an optical disc, and the like. Machine-readable storage medium 506 may be disposed within system 500, as illustrated in FIG. 5. In this case, the executable instructions may be installed on system 500. Alternatively, machine-readable storage medium 506 may be a portable, external, or remote storage medium that allows system 500 to download the instructions from the portable/external/remote storage medium. In this case, the executable instructions may be part of an installation package.

Machine-readable storage medium 506 stores instructions to be executed by a processor (e.g., processor 502) including instructions 508, 510, 512, 514, 516, 518, 520, and 522 to operate HS analysis system 200 as previously described and illustrated with reference to FIG. 2. Processor 502 may execute instructions 508 to crawl a plurality of data sources to retrieve an indicator value for each of a plurality of indicators for each of a plurality of countries. The indicators may include economic indicators, import/export indicators for each of a plurality of HS numbers, and world trade indicators. In one example, processor 502 may also execute instructions to crawl a portion of the plurality of data sources to retrieve an updated indicator value for each of a portion of the plurality of indicators multiple times each day. In another example, processor 502 may also execute instructions to crawl the plurality of data sources based on an update frequency of each data source. Processor 502 may execute instructions 510 to scrub and normalize each retrieved indicator value. Processor 502 may execute instructions 512 to receive a request for a report for a selected HS number from the plurality of HS numbers.

Processor 502 may execute instructions 514 to assign a weight to each indicator based on a potential level of success for goods in a market. Processor 502 may execute instructions 516 to multiply each scrubbed and normalized indicator value by the assigned weight for the indicator to provide a weighted value for each indicator for each country for the selected HS number. Processor 502 may execute instructions 518 to sum the weighted values for each country to provide a total value for each country for the selected HS number. Processor 502 may execute instructions 520 to rank the total values to generate a report for the selected HS number. Processor 502 may execute instructions 522 to provide the requested report indicating a success for sales of the product indicated by the selected HS number in each country. In one example, processor 502 may also execute instructions to store each scrubbed and normalized indicator value in a database.

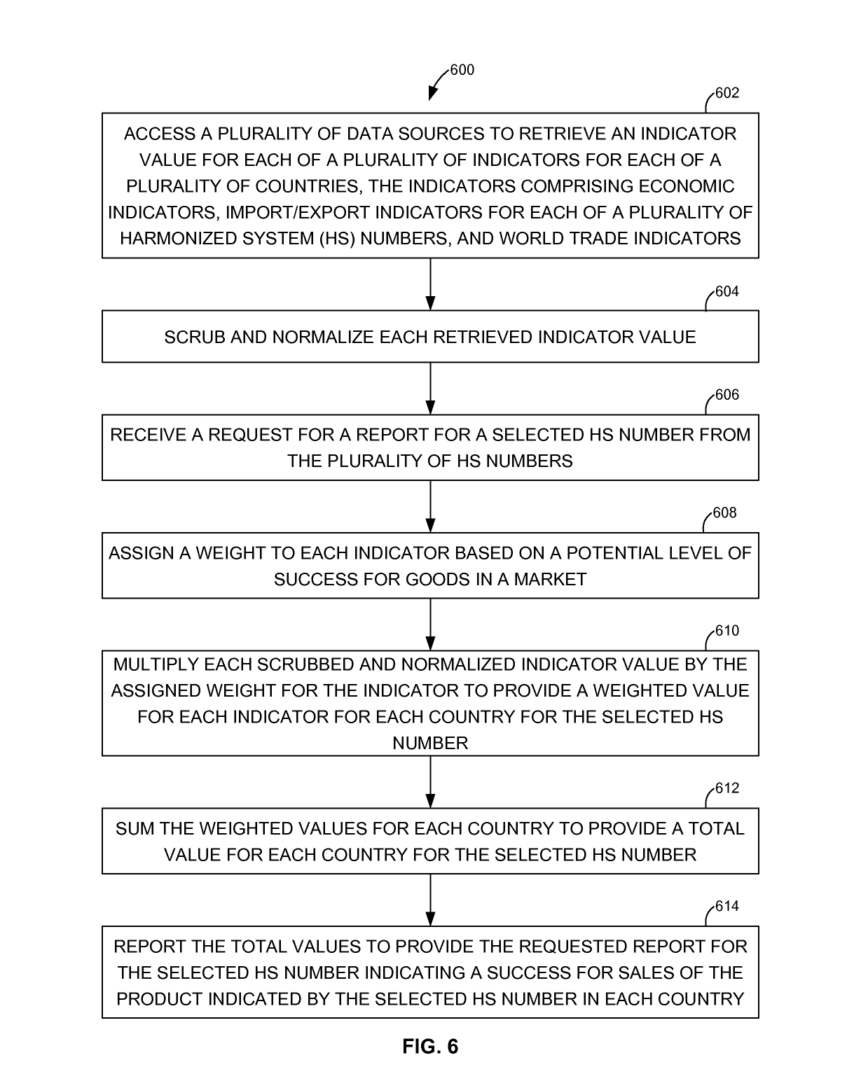

FIG. 6 is a flow diagram illustrating one example of a method 600 for analyzing an HS number. In one example, method 600 is executed by a processing system, such as processing system 500 previously described and illustrated with reference to FIG. 5. At 602, a plurality of data sources are accessed to retrieve an indicator value for each of a plurality of indicators for each of a plurality of countries, the indicators comprising economic indicators, import/export indicators for each of a plurality of HS numbers, and world trade indicators. In one example, each data source is accessed based on an update frequency of each data source. In another example, a portion of the plurality of data sources is accessed to retrieve an updated indicator value for each of a portion of the plurality of indicators multiple times each day.

The 604, each retrieved indicator value is scrubbed and normalized. At 606, a request is received for a report for a selected HS number from the plurality of HS numbers. At 608, a weight is assigned to each indicator based on a potential level of success for goods in a market. At 610, each scrubbed and normalized indicator value is multiplied by the assigned weight for the indicator to provide a weighted value for each indicator for each country for the selected HS number. At 612, the weighted values for each country are summed to provide a total value for each country for the selected HS number.

At 614, the total values are reported to provide the requested report for the selected HS number indicating a success for sales of the product indicated by the selected HS number in each country. In one example, the method further includes sorting the total values from highest to lowest to provide a ranking of the countries indicating a success for sales of the product indicated by the selected HS number. In another example, the method further includes storing each scrubbed and normalized indicator value in a database.

The HS number analysis system described herein generates market research reports based on data from various sources. The reports are generated based on a number of indicators including, for example, economic indicators, import and export indicators, world trade indicators, and other indicators. The data is aggregated and calculations are made to automatically generate, in real time (i.e., within a few seconds of a request for a report), reports useful in measuring market demand instantaneously, spotting pricing inefficiencies, and measuring trade of goods across the globe.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a crawler to access a plurality of data sources to retrieve an indicator value for each of a plurality of indicators for each of a plurality of countries, the indicators comprising economic indicators, import/export indicators for each of a plurality of Harmonized System (HS) numbers, and world trade indicators;
a normalizer to scrub and normalize each retrieved indicator value;
a database to store each normalized indicator value;
an interface to receive a request for a report for a selected HS number from the plurality of HS numbers and to provide the requested report for the selected HS number; and
an analysis engine to, for the selected HS number:
assign a weight to each indicator based on a potential level of success for goods in a market;
multiply each normalized indicator value by the assigned weight for the indicator to provide a weighted value for each indicator for each country;
sum the weighted values for each country to provide a total value for each country; and
rank the total values to provide the requested report for the selected HS number indicating a success for sales of the product indicated by the selected HS number in each country.

2. The system of claim 1, wherein the indicators further comprise at least one of instantaneous demand data for each HS number and social network data for each HS number.

3. The system of claim 1, wherein the indicators further comprise at least one of estimated shipping costs for each HS number, cost of goods pricing for each HS number, and average purchase price for each HS number.

4. The system of claim 1, wherein the economic indicators comprise at least one of gross domestic product, gross domestic product growth, discretionary income, income per capita, money growth, inflation, and population demographics.

5. The system of claim 1, wherein the import/export indicators for each of the plurality of HS numbers comprise at least one of taxes and tariffs, amount imported, amount exported, trade imbalance, estimated shipping cost, average paperwork cost, and imports of goods and services percentage.

6. The system of claim 1, wherein the world trade indicators comprise at least one of strength of legal rights, number of documents to import, logistics performance, labor participation rate, and ease of doing business.

7. The system of claim 1, wherein the data sources have different update frequencies, and
wherein the crawler accesses each data source based on the update frequency of each data source.

8. The system of claim 1, wherein the crawler accesses each data source via the Internet.

9. The system of claim 1, wherein the crawler accesses public data sources and private data sources.

10. The system of claim 1, wherein the crawler retrieves updated indicator values for each of a portion of the plurality of indicators multiple times each day.

11. The system of claim 1, wherein the import/export indicators for each of the plurality of HS numbers are based on up to the first six digits of each HS number.

12. A machine-readable storage medium encoded with instructions, the instructions executable by a processor of a system to cause the system to:
crawl a plurality of data sources to retrieve an indicator value for each of a plurality of indicators for each of a plurality of countries, the indicators comprising economic indicators, import/export indicators for each of a plurality of Harmonized System (HS) numbers, and world trade indicators;
scrub and normalize each retrieved indicator value;
receive a request for a report for a selected HS number from the plurality of HS numbers;
assign a weight to each indicator based on a potential level of success for goods in a market;
multiply each scrubbed and normalized indicator value by the assigned weight for the indicator to provide a weighted value for each indicator for each country for the selected HS number;
sum the weighted values for each country to provide a total value for each country for the selected HS number;
rank the total values to generate a report for the selected HS number; and
provide the requested report indicating a success for sales of the product indicated by the selected HS number in each country.

13. The machine-readable storage medium of claim 12, wherein the instructions are executable by the processor to further cause the system to:
crawl a portion of the plurality of data sources to retrieve an updated indicator value for each of a portion of the plurality of indicators multiple times each day.

14. The machine-readable storage medium of claim 12, wherein the instructions are executable by the processor to further cause the system to:
crawl the plurality of data sources based on an update frequency of each data source,
wherein the data sources have different update frequencies.

15. The machine-readable storage medium of claim 12, wherein the instructions are executable by the processor to further cause the system to:
store each scrubbed and normalized indicator value in a database.

16. A method comprising:
accessing, via a processing system, a plurality of data sources to retrieve an indicator value for each of a plurality of indicators for each of a plurality of countries, the indicators comprising economic indicators, import/export indicators for each of a plurality of Harmonized System (HS) numbers, and world trade indicators;
scrubbing and normalizing, via the processing system, each retrieved indicator value;
receiving, via the processing system, a request for a report for a selected HS number from the plurality of HS numbers;
assigning, via the processing system, a weight to each indicator based on a potential level of success for goods in a market;
multiplying, via the processing system, each scrubbed and normalized indicator value by the assigned weight for the indicator to provide a weighted value for each indicator for each country for the selected HS number;
summing, via the processing system, the weighted values for each country to provide a total value for each country for the selected HS number; and
reporting, via the processing system, the total values to provide the requested report for the selected HS number indicating a success for sales of the product indicated by the selected HS number in each country.

17. The method of claim 16, wherein the data sources have different update frequencies, and
wherein accessing the plurality of data sources comprises accessing the plurality of data sources based on the update frequency of each data source.

18. The method of claim 16, wherein accessing the plurality of data sources comprises accessing a portion of the plurality of data sources to retrieve an updated indicator value for each of a portion of the plurality of indicators multiple times each day.

19. The method of claim 16, further comprising:
sorting the total values from highest to lowest to provide a ranking of the countries indicating a success for sales of the product indicated by the selected HS number.

20. The method of claim 16, further comprising:
storing, via the processing system, each scrubbed and normalized indicator value in a database.
